(19) United States
(12) Patent Application Publication
(10) Pub. No.: US 2004/0123440 A1
(43) Pub. Date: Jul. 1, 2004

(54) Methods for assembling or reworking a rotary actuator assembly for a media data storage device

(76) Inventors: Christopher Nguyen, Union City, CA (US); Joseph T. Castagna, San Jose, CA (US); Richard G. Ramsdell, Saratoga, CA (US)

Correspondence Address: Sheldon R. Meyer, FLIESLER DUBB MEYER & LOVEJOY LLP, Fourth Floor, Four Embarcadero Center, San Francisco, CA, 94111-4156, US

(21) Appl. No.: 10/366,235

(22) Filed: Feb. 13, 2003

Related U.S. Application Data
(60) Provisional application No. 60/437,112, filed on Dec. 30, 2002.

(51) Int. Cl. B23P 6/00; H04R 31/00

(52) U.S. Cl. 29/402.04; 29/426.1; 29/402.08; 29/603.02; 29/603.03

(57) ABSTRACT

Methods in accordance with the present invention can be used to assemble or rework a rotary actuator assembly for a media data storage device having one or more disks. One such method for assembling a rotary actuator assembly includes connecting at least one arm to a mounting block wherein the mounting block includes a bore and a spacer, the spacer having threaded holes on a top surface and a bottom surface in order to receive screws. This description is not intended to be a complete description of, or limit the scope of, the invention. Other features, aspects, and objects of the invention can be obtained from a review of the specification, the figures, and the claims.

### PRIORITY CLAIM

This application claims priority to the following U.S. Provisional Patent Application:

U.S. Provisional Patent Application No. 60/437,112, entitled “Methods for Assembling or Reworking a Rotary Actuator Assembly for a Rotatable Media Data Storage Device,” Attorney Docket No. PANA-01003US1, filed Dec. 30, 2002.

### CROSS-REFERENCED CASES

This application incorporates by reference all of the following co-pending applications:

U.S. Patent Application No. ______, entitled “Rotary Actuator Assembly for a Rotatable Media Data Storage Device,” Attorney Docket No. PANA-01003US2, filed herewith.

U.S. Patent Application No. ______, entitled “Modular Rotary Actuator Assembly for a Rotatable Media Data Storage Device,” Attorney Docket No. PANA-01028US2, filed herewith.

U.S. Patent Application No. ______, entitled “Methods for Assembling or Reworking a Modular Rotary Actuator Assembly for a Rotatable Media Data Storage Device,” Attorney Docket No. PANA-01028US3, filed herewith.

U.S. Patent Application No. ______, entitled “Removable Bearing Assembly for a Rotary Actuator Assembly in a Rotatable Media Data Storage Device,” Attorney Docket No. PANA-01034US2, filed herewith.

U.S. Patent Application No. ______, entitled “Methods for Seating a Removable Bearing Assembly in a Rotary Actuator Assembly for a Rotatable Media Data Storage Device,” Attorney Docket No. PANA-01034US3, filed herewith.

### FIELD OF THE INVENTION

The present invention relates generally to rotatable media data storage devices, as for example magnetic or optical hard disk drive technology, and more specifically to actuator assemblies for positioning heads in hard disk drives.

### BACKGROUND OF THE INVENTION

Computer systems are fundamentally comprised of subsystems for storing and retrieving information, manipulating information, and displaying information. Nearly all computer systems today use optical, magnetic or magneto-optical storage media to store and retrieve the bulk of a computer system's data. Successive generations of ever more powerful microprocessors, and increasingly complex software applications that take advantage of these microprocessors, have driven the storage capacity needs of systems higher and have simultaneously driven read and write performance demands higher. Magnetic storage remains one of the few viable technologies for economically storing large amounts of information with acceptable read and write performance.

Market pressures place ever greater demands on hard disk drive manufacturers to reduce drive costs. In order to maintain market advantage, new hard disk drive designs typically incorporate greater efficiency in device operating tolerances or manufacturability.

There are basic components common to nearly all hard disk drives. A hard disk drive typically contains one or more disks clamped to a rotating spindle, a head for reading or writing information to the surface of each disk, and an actuator assembly utilizing linear or rotary motion for positioning the head for retrieving particular information or writing information to a particular location on the disk. A rotary actuator is a complex assembly that couples the head to a pivot point that sweeps the head across the surface of the rotating disk. The assembly typically couples the head to a flexible member called a suspension, which is then coupled to the pivotally mounted actuator assembly.

The current state of the art is to use one of two basic designs for attaching the suspensions with the actuator assembly: (1) the one-piece E-shaped block assembly (generally referred to as an E-block) or (2) the multi-piece assembly with unitary mounted suspension (generally referred to as Unamount). The E-block, typically made of aluminum or magnesium, is cast or extruded as a singular block element and machined to provide attachment points for suspensions (the attachment points form rigid arms). One or two suspensions are connected with each arm by swaging or staking through a machined bore in the arm which is aligned with a bore in the suspension. Swaging uses steel balls slightly larger in diameter than the machined bores to apply axial forces which deform and attach the suspensions to the arms.

Swaging applies force to the suspension and can deform a cantilevered portion of the suspension used to hold a slider on which ahead is mounted. Deformation of the cantilevered portion of the suspension can lead to structural resonance variation and reduction in the reliability of ramp-based head loading and unloading. In order to control the amount of deforming force applied to the suspension with each impact, multiple steel balls with increasing diameters are often used in the swaging process. Damage can still result to the suspension. As data storage tracks are packed more tightly and as actuator arm block sizes shrink, requiring more precise performance of the actuator assembly, this problem will likely become acute, impacting future manufacturing yields. Further, it is difficult to maintain the preset spring rate and gram load of the suspensions during the swaging process, and suspension alignment and staking must be supervised and monitored, increasing the cost and decreasing the speed of assembly of the drives.

The Unamount assembly uses an actuator arm plate, typically stamped from a thin stainless steel sheet, that includes a circular bore that when coupled to spacer elements, forms a cylindrical bore designed to receive a bearing assembly. Each suspension is micro-spot welded to each actuator arm plate, which is then secured to the spacers and other such arm assemblies in a rigid manner to form the actuator assembly. The Unamount assembly has significant disadvantages including higher assembly cost, difficult assembly cleaning, potential for component damage during rework (the rigid assembly must be unfastened and the bearing assembly removed or exposed to detach a single arm plate), and less design flexibility due to the difficulty of structurally tuning the arm and suspension resonances at the same time.

### BRIEF DESCRIPTION OF THE FIGURES

Further details of embodiments of the present invention are explained with the help of the attached drawings in which:

FIG. 1A is an exploded view of a typical hard disk drive utilizing an actuator assembly in accordance with one embodiment of the present invention.

FIG. 1B is a close-up view of a head suspension assembly used in the hard disk drive of FIG. 1A, showing head, slider and suspension.

FIG. 1C is an illustration of the rotary motion of a head suspension assembly of FIG. 1B across the surface of a disk.

FIG. 2 is an exploded view of an actuator assembly in accordance with one embodiment of the invention.

FIG. 3 is a block diagram of a method for manufacturing an actuator assembly in accordance with one embodiment of the invention.

FIG. 4 is a block diagram of a method for reworking an actuator assembly in accordance with one embodiment of the invention.

### DETAILED DESCRIPTION

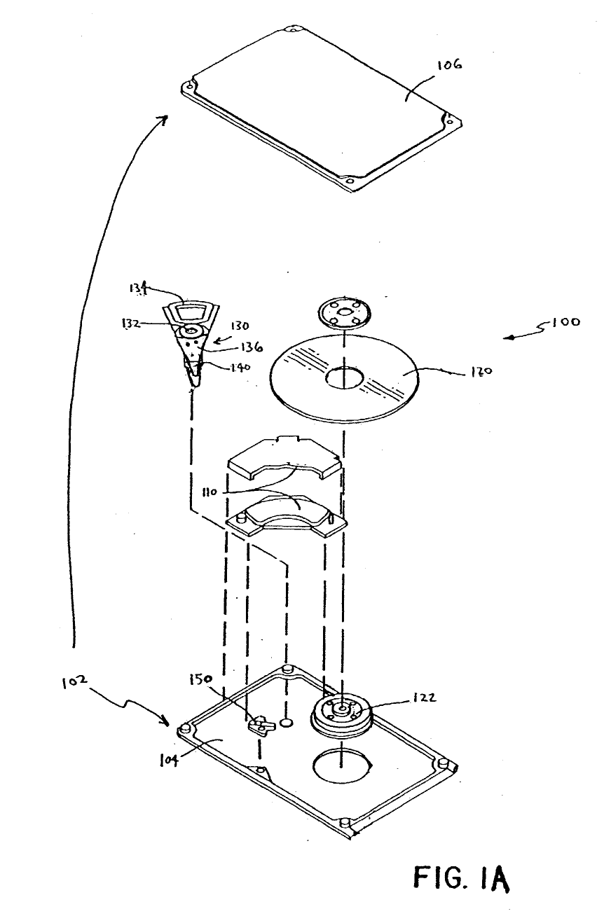

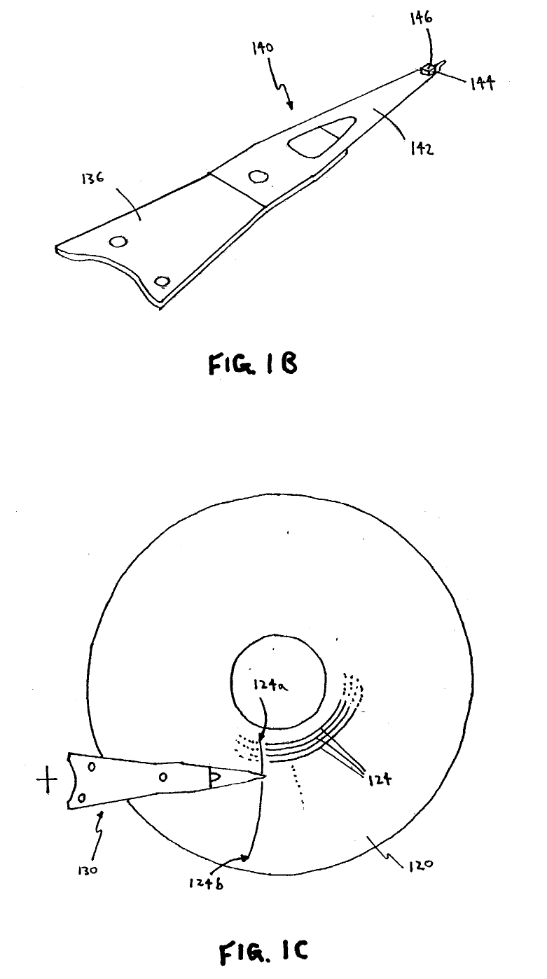

FIG. 1A is an exploded view of a hard disk drive 100 utilizing an actuator assembly in accordance with one embodiment of the present invention. The hard disk drive 100 has a housing 102 which is formed by a housing base 104 and a housing cover 106. A single disk 120 is attached to the hub of a spindle motor 122, with the spindle motor 122 mounted to the housing base 104. The disk 120 can be made of a light aluminum alloy, ceramic/glass or other suitable substrate, with magnetic material deposited on one or both sides of the disk 120. The magnetic layer has tiny domains of magnetization for storing data transferred through heads. The invention described herein is equally applicable to technologies using other media, as for example, optical media. Further, the invention described herein is equally applicable to devices having any number of disks attached to the hub of the spindle motor. The disks are connected to a rotating spindle 122 (for example by clamping), spaced apart to allow heads to access the surfaces of each disk, and rotated in unison at a constant or varying rate typically ranging from less than 3,600 RPM to over 15,000 RPM (speeds of 4,200 and 5,400 RPM are common in hard disk drives designed for mobile devices such as laptops).

The actuator assembly 130 is pivotally mounted to the housing base 104 by a bearing assembly 132 and sweeps an arc, as shown in FIG. 1C, between at least an inner actuator addressable diameter of the disk 124a and an outer actuator addressable diameter of the disk 124b. Attached to the housing 104 are upper and lower magnet return plates 110 and at least one magnet that together form the stationary portion of the voice coil motor assembly 112. The voice coil 134 is mounted to the actuator assembly 130 and positioned in the air gap of the voice coil motor 112 which applies a force to the actuator assembly 130 to provide the pivoting motion about the bearing assembly 132. The voice coil motor allows for precise positioning of the heads 146 along the surface of the disk 120. The voice coil motor 112 is coupled with a servo system (not shown) to accurately position the head 146 over a specific track on the disk 120. The servo system acts as a guidance system, using positioning code (for example grey code) read by the head 146 from the disk 120 to determine the position of the head 146 on tracks 124 on the disk 120. The actuator assembly 130 is shown in FIG. 1B to have an overall wedge-shape, but could alternatively have a variety of shapes: for example, the actuator assembly could be rectangular or oblong, or shaped like an arrow.

The heads 146 (FIG. 1B) read and/or write data to the disks. Each side of a disk 120 can have an associated head 146, and the heads 146 are collectively coupled to the actuator assembly 130 such that the heads 146 pivot in unison. When not in use, the heads 146 can rest on the stationary disk 120 (typically on an inner portion of the disk that does not contain data) or on a ramp 150 positioned either adjacent to a disk or just over the disk surface.

FIG. 1B details a subassembly commonly referred to as a head suspension assembly (HSA) 140, comprising the head 146 attached to a slider 144, which is further attached to a flexible suspension member (a suspension) 142. The spinning of the disk 120 creates air pressure beneath the slider 144 that lifts the slider 144 and consequently the head 146 off of the surface of the disk 120, creating a micro-gap of typically less than four micro-inches between the disk 120 and the head 146 in one embodiment. The suspension 142 is bent or shaped to act as a spring such that a load force is applied to the surface of the disk. The “air bearing” created by the spinning of the disk 120 resists the spring force applied by the suspension 142, and the opposition of the spring force and the air bearing to one another allow the head 146 to trace the surface contour of the rotating disk surface, which is likely to have minute warpage, without “crashing” against the disk surface. When a head “crashes”, the head collides with a surface such that the head is damaged.

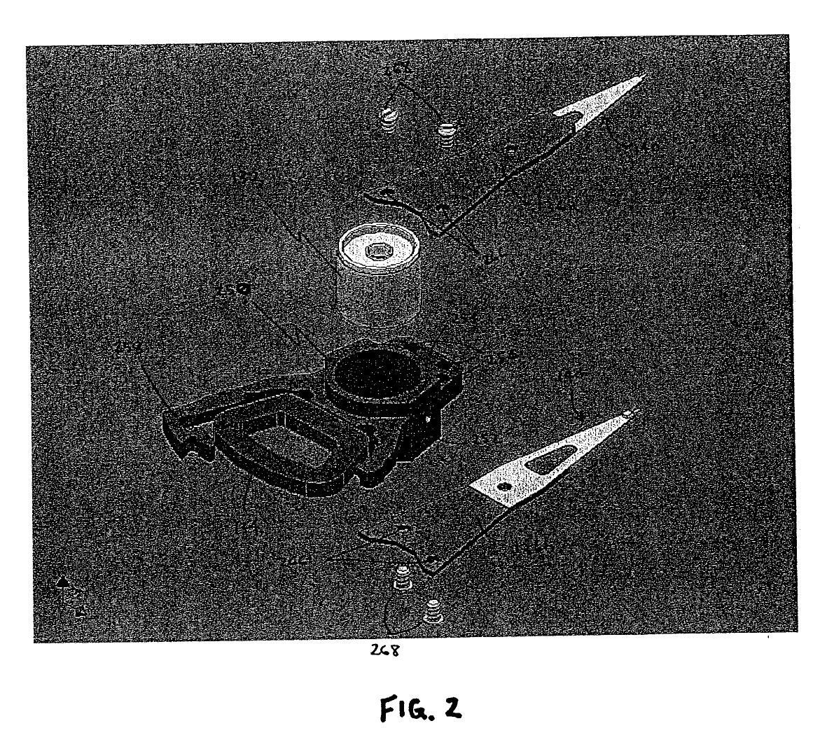

The HSA 140 is connected to the actuator assembly by a rigid arm 136. As described above, the suspension 142 is typically swaged to the rigid arm, or micro-spot welded to an arm plate which forms part of the bearing assembly bore. FIG. 2 is an exploded view of one embodiment of the actuator assembly 130 contemplated in the present invention. The actuator assembly 130 comprises a mounting block 250 having a solid bore 252 for receiving a bearing assembly 132. A spacer 254 is formed at a first end of the mounting block 250 (by casting, extruding or milling, for example). The spacer 254 is at least as thick as a disk 120 and has at least one, and preferably four threaded holes 256 extending through the width of the spacer 254 for engaging the threads of screws 268. In alternative embodiments one or more threaded holes 256 through the top and bottom of the spacer only partially penetrate the spacer. In still other embodiments the spacer holes 256 are not threaded, but smooth for receipt of bolts or other fasteners. A voice coil holder 258 is mounted at a second end of the mounting block 250, and retains a voice coil 134. The voice coil holder 258 can be cast as part of a singular block element with the mounting block 250, adhesively bonded or plastic over-molded onto the mounting block 250, or alternatively welded or soldered to the mounting block 250. One of ordinary skill in the art can appreciate the different methods for fastening the voice coil holder 258 to the mounting block 250.

Providing a solid bore 252 simplifies the cleaning process and allows flexibility in choosing the technique for journaling pivot bearings. The bearing assembly 132 can be comprised of a separate cartridge bearing which can be installed after head stack assembly cleaning, or alternatively can include discrete bearings positioned in the actuator bore 252.

As indicated above, the HSA 140 is connected with the actuator assembly 130 by an arm 136. The arm 136 can be stamped or milled and made from stainless steel, aluminum, magnesium, titanium or other suitable material. The arm 136 includes at least one, but preferably two holes 266 at the distal end for receiving screws 268. In FIG. 2, the two holes 266 are shown offset so that the holes of a first arm 136a mounted to the top surface of the spacer 254 and the holes of a second arm 136b mounted to the bottom surface of the spacer 254 are aligned with different threaded holes 256 in the spacer. This arrangement prevents screws 268 which engage the threaded holes 256 from opposite surfaces of the spacer 254 from interfering with one another. This arrangement also allows an arm to cover threaded holes 256 which are not aligned with holes 266 in the arm 136 to reduce foreign material entering the threaded holes 256. In one embodiment, the suspensions 142 are micro-spot welded to the proximal end of the arm 136. In other embodiments, the suspensions 142 can be adhesively bonded to the arm 136. In still other embodiments the suspensions 142 and the respective arms 136a/136b comprise single stamped pieces.

As indicated above, first arm 136a is removably fastened to the top surface of the spacer 254 by at least one, and preferably two screws 268 such that the suspension applies a load force against the top surface of a disk 120 mounted in the plane of the spacer 254. Also as indicated above, the second arm 136b is removably fastened to the bottom surface of the spacer 254 by at least one, and preferably two screws 268 such that the suspension applies a load force against the bottom surface of the disk 120. Thus, the disk 120 is positioned between the top and bottom arm 136a and 136b. In other embodiments, the arms 136 are removably fastened to the spacer 254 using bolts. In still other embodiments, the arms 136 are removably fastened to the spacer 254 using pressure fittings. One of ordinary skill in the art can appreciate the different means for attaching the arms 136 to the spacer 254. Actuator assemblies in accordance with embodiments of the present invention can be built at a relatively low cost and without the misalignment and deformation associated with the prior art assemblies. Further, arms 136 having different thicknesses or shapes can be easily substituted, thus allowing tuning of resonant frequencies according to the needs of the product while minimizing additional manufacturing costs. These needs may be dictated by spindle speed, shock and vibration performance requirements or other parameters.

The invention described herein is equally applicable to technologies using other read/write devices, for example lasers. In such an alternative embodiment, the HSA 140 would be substituted with an alternative read/write device, for example a laser, which could be either removably or fixedly attached to an arm 136, in a similar manner as described above (micro-spot welding, adhesives, single-piece stamping). The arm 136 is subsequently removably fastened to mounting block 250 in the manner described above.

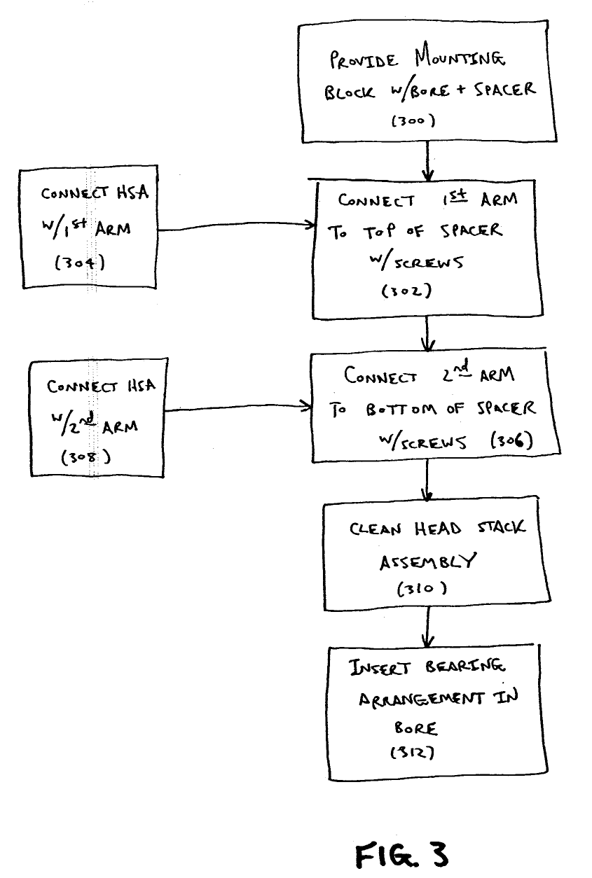

FIG. 3 is a representation of a method for manufacturing the actuator assembly represented in FIG. 2. As shown as the first step 300, a mounting block 250 is provided, the mounting block having a central, cylindrical bore 252. Further, the mounting block has a spacer 254 at a first end for attaching arms 136 and a voice coil holder 258 at a second end that retains a voice coil. A first pre-assembled HSA 140 is micro-spot welded, or alternately adhesively fastened, to a first arm 136a (step 304) and similarly a second pre-assembled HSA 140 is micro-spot welded to a second arm 136b (step 308). In other embodiments, an arm and a suspension can be stamped as a single piece, wherein a head connected with a slider could be mounted to each arm/suspension prior to connecting each arm/suspension to the mounting block.

The first arm 136a is removably fastened to the top surface of the spacer (step 302) and the second arm 136b is removably fastened to the bottom surface of the spacer (step 306). The completed assembly, known as the head stack assembly, can then be cleaned (step 310) prior to mounting the bearing assembly 132. The heads stack assembly is then mounted onto the bearing assembly 132 (step 312) such that the head stack assembly rotates freely about the bearing assembly. As described in regards to FIGS. 1A and 2, the bearing assembly 132 can comprise a cartridge bearing, or discrete bearings solidly attached in the actuator bore section. In other embodiment at least some of the HSAs can be mounted to the mounting block after the mounting block is positioned onto the bearing assembly.

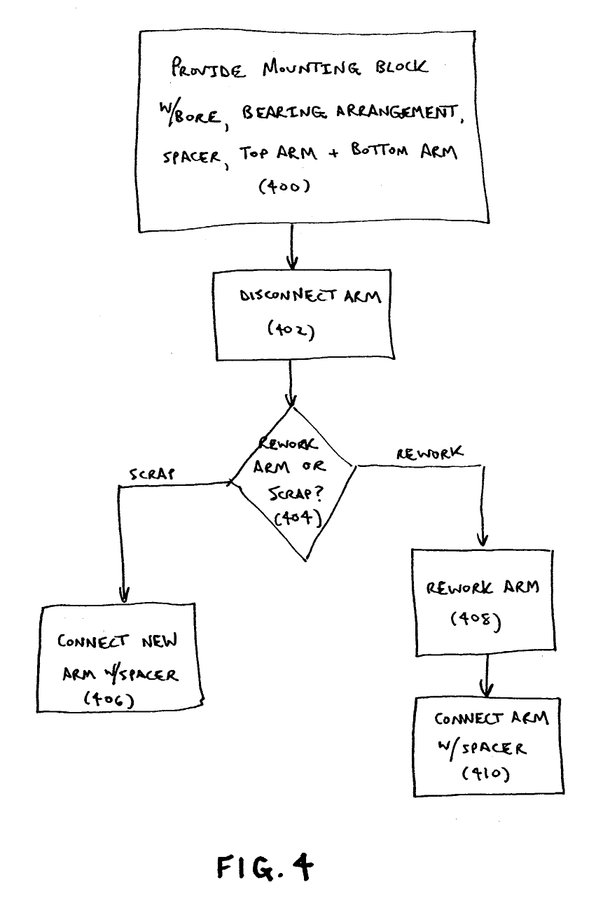

FIG. 4 is a representation of a method for reworking an actuator assembly represented in FIG. 2. If the actuator assembly 130 is mounted within hard disk drive 100 (step 400), the actuator assembly is removed from the hard disk drive 100. The arm requiring rework (step 402) is unfastened from the actuator assembly. The arm is then either replaced with a substitute HSA (steps 404, 406) connected with an arm or the unfastened HSA connected with an arm is repaired (steps 404,408), and the arm is subsequently reattached to the actuator assembly 130 (step 410). The method represented in FIG. 4 provides the significant advantage of fast rework without removing the bearing assembly 132.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalence.

1. A method to assemble a rotary disk drive actuator that is adapted to access a data storage medium comprising the steps of:
providing amounting block that is adapted to sweep an arc extending at least between an outer diameter of a disk and an inner diameter of the disk, which mounting block including a bore and a spacer, the spacer having threaded holes on a top surface and a bottom surface in order to receive screws; and in any order the further steps of:
connecting a bottom arm with the bottom surface of the spacer by one or more screws;
connecting a top arm with the top surface of the spacer by one or more screws; and
inserting a bearing arrangement into the bore.

2. The method of claim 1, wherein the method further comprises the step of cleaning the mounting block, top arm and bottom arm prior to inserting a bearing arrangement into the bore.

3. A method to assemble a rotary actuator assembly that is adapted to access a data storage medium in a data storage device comprising the steps of:
providing a mounting block that is adapted to sweep an arc extending between at least an outer diameter of a disk and an inner diameter of the disk, which mounting block including a bore and a spacer, the spacer having threaded holes on a top surface and a bottom surface in order to receive screws; and
in any order the further steps of:
connecting a bottom arm with the bottom surface of the spacer by one or more screws;
connecting a top arm with the top surface of the spacer by one or more screws;
inserting a bearing arrangement into the bore; and
inserting the mounting block into the data storage device.

4. The method of claim 3, wherein the method further comprises the step of cleaning the mounting block, top arm and bottom arm prior to inserting a bearing arrangement into the bore.

5. A method to assemble a rotary actuator assembly having a mounting block that is adapted to sweep an arc extending between an outer diameter of a disk and an inner diameter of the disk, which mounting block including a bore and a spacer, the spacer having threaded holes on a top surface and a bottom surface in order to receive screws comprising the steps of:
connecting a bottom arm with the bottom surface of the spacer by one or more screws;
connecting a top arm with the top surface of the spacer by one or more screws; and
inserting a bearing arrangement into the bore.

6. The method of claim 5, wherein the method further comprises the step of cleaning the mounting block, top arm and bottom arm prior to inserting a bearing arrangement into the bore.

7. A method to assemble a rotary actuator assembly in a data storage device, the rotary actuator assembly having a mounting block that is adapted to sweep an arc extending at least between an outer diameter of a disk and an inner diameter of the disk, which mounting block including a bore and a spacer, the spacer having threaded holes on a top surface and a bottom surface in order to receive screws comprising the steps of:
connecting a bottom arm with the bottom surface of the spacer by one or more screws;
connecting a top arm with the top surface of the spacer by one or more screws;
inserting a bearing arrangement into the bore; and
inserting the mounting block into the data storage device.

8. The method of claim 7, wherein the method further comprises the step of cleaning the mounting block, top arm and bottom arm prior to inserting a bearing arrangement into the bore.

9. A method to rework a rotary disk drive actuator that is adapted to access a data storage medium comprising the steps of:
starting with a mounting block adapted to sweep an arc extending between at least an outer diameter of the disk and an inner diameter of the disk, the mounting block including a bore, a bearing arrangement associated with the bore, a spacer having threaded holes on a top surface and a bottom surface in order to receive screws, a first top arm removably fastened with the top surface of the spacer, and a first bottom arm removably fastened with the bottom surface of the spacer;
disconnecting a first top arm from the top surface of the spacer by removing one or more screws; and
connecting a second top arm to the top surface of the spacer by one or more screws.

10. A method to rework a rotary actuator assembly having a mounting block adapted to sweep an arc extending between at least an outer diameter of the disk to an inner diameter of the disk, the mounting block including a bore, a bearing arrangement associated with the bore, a spacer having threaded holes on a top side and a bottom side for receipt of screws, a first top arm removably fastened with the top surface of the spacer, and a first bottom arm removably fastened with the bottom surface of the spacer, comprising the steps of:
disconnecting the first top arm from the top surface of the spacer by removing one or more screws; and
connecting a second top arm to the top surface of the spacer by one or more screws.

11. A method to rework a rotary actuator assembly in a data storage device, the rotary actuator assembly having a mounting block adapted to sweep an arc extending between at least an outer diameter of the disk to an inner diameter of the disk, the mounting block including a bore, a bearing arrangement associated with the bore, a spacer having threaded holes on a top side and a bottom side for receipt of screws, a first top arm removably fastened with the top surface of the spacer, and a first bottom arm removably fastened with the bottom surface of the spacer, comprising the steps of:
removing the rotary actuator assembly from the data storage device;
disconnecting the first top arm from the top surface of the spacer by removing one or more screws;
connecting a second top arm to the top surface of the spacer by one or more screws; and
inserting the rotary actuator assembly into the data storage device.

12. A method to rework a rotary disk drive actuator that is adapted to access a data storage medium comprising the steps of:
starting with a mounting block adapted to sweep an arc extending between at least an outer diameter of the disk to an inner diameter of the disk, the mounting block including a bore, a bearing arrangement associated with the bore, a spacer having threaded holes on a top side and a bottom side for receipt of screws, a first top arm removably fastened with the top surface of the spacer, and a first bottom arm removably fastened with the bottom surface of the spacer;
disconnecting the first bottom arm from the bottom surface of the spacer by removing one or more screws; and
connecting a second bottom arm to the bottom surface of the spacer by one or more screws.

13. A method to rework a rotary actuator assembly having a mounting block adapted to sweep an arc extending between at least an outer diameter of the disk to an inner diameter of the disk, the mounting block including a bore, a bearing arrangement associated with the bore, a spacer having threaded holes on a top side and a bottom side for receipt of screws, a first top arm removably fastened with the top surface of the spacer, and a first bottom arm removably fastened with the bottom surface of the spacer, comprising the steps of:
disconnecting the first bottom arm from the bottom surface of the spacer by removing one or more screws; and
connecting a second bottom arm to the bottom surface of the spacer by one or more screws.

14. A method to rework a rotary actuator assembly in a data storage device, the rotary actuator assembly having a mounting block adapted to sweep an arc extending between at least an outer diameter of the disk to an inner diameter of the disk, the mounting block including a bore, a bearing arrangement associated with the bore, a spacer having threaded holes on a top side and a bottom side for receipt of screws, a first top arm removably fastened with the top surface of the spacer, and a first bottom arm removably fastened with the bottom surface of the spacer, comprising the steps of:
removing the rotary actuator assembly from the data storage device;
disconnecting the first bottom arm from the bottom surface of the spacer by removing one or more screws;
connecting a second bottom arm to the bottom surface of the spacer by one or more screws; and
inserting the rotary actuator assembly into the data storage device.

15. A method to assemble a rotary disk drive actuator that is adapted to access a data storage medium comprising the steps of:
providing a mounting block, which mounting block including a bore and a spacer, the spacer configured to receive a fastener on a top surface and a bottom surface and in any order the further steps of:
connecting a bottom arm with the bottom surface of the spacer by one or more fasteners; and
connecting a top arm with the top surface of the spacer by one or more fasteners.

16. A method to assemble a rotary actuator assembly that is adapted to access a data storage medium in a data storage device comprising the steps of:
providing amounting block, which mounting block including a bore and a spacer, the spacer configured to receive a fastener on one of a top surface and a bottom surface; and
in any order the further steps of:
connecting an arm with one of the top surface and the bottom surface of the spacer by one or more fasteners.
